(19) United States
(12) Patent Application Publication
(10) Pub. No.: US 2002/0082464 A1
(43) Pub. Date: Jun. 27, 2002

(54) Medical imaging system localization method and apparatus

(76) Inventors: Christopher N. Japp, Milwaukee, WI (US); Douglas E. Stern, Waukesha, WI (US); Raymond J. Kelley, Waukesha, WI (US); Jack Oblein, Kenosha, WI (US); David M. Oreshack, Delafield, WI (US)

Correspondence Address: Patrick S. Yoder, Suite 330, 7915 FM 1960 West, Houston, TX, 77070, US

(21) Appl. No.: 09/747,547

(22) Filed: Dec. 22, 2000

(51) Int. Cl. G06F 17/30

(52) U.S. Cl. 600/10; 707/10

(57) ABSTRACT

The present technique is associated with geographically locating a medical resource. The technique allows a client to interact with a remote medical resource locator system via a network interface, and to enter and transmit client data to the medical resource locator system for a location analysis. Accordingly, the client receives a resource location report based on a desired geographic region for the medical resource.

### FIELD OF THE INVENTION

The present invention relates generally to geographic locator systems and, more particularly, to a technique for geographically locating a desired medical resource. The present technique permits data exchange between a medical locator system and a remote interface via a network, allowing a client to interact with the medical resource locator system and to receive a locator report based on client data.

### BACKGROUND OF THE INVENTION

Medical facilities require various medical resources, such as human resources, medical systems, equipment and instruments, to provide healthcare services to patients. For example, medical diagnostic and imaging systems are ubiquitous in modem healthcare facilities. Such systems provide invaluable tools for identifying, diagnosing and treating physical conditions and greatly reduce the need for surgical diagnostic intervention. In many instances, final diagnosis and treatment proceed only after an attending physician or radiologist has complemented conventional examinations with detailed images of relevant areas and tissues via one or more imaging modalities.

Currently, a number of modalities exist for medical diagnostic and imaging systems. These include computed tomography (CT) systems, x-ray systems (including both conventional and digital or digitized imaging systems), magnetic resonance (MR) systems, positron emission tomography (PET) systems, ultrasound systems, nuclear medicine systems, and so forth. In many instances, these modalities complement one another and offer the physician a range of techniques for imaging particular types of tissue, organs, physiological systems, and so forth. Healthcare institutions often dispose of several such imaging systems at a single or multiple facilities, permitting its physicians to draw upon such resources as required by particular patient needs.

Modern medical diagnostic systems typically include circuitry for acquiring image data and for transforming the data into a useable form, which is then processed to create a reconstructed image of features of interest within the patient. The image data acquisition and processing circuitry is often referred to as a “scanner” regardless of the modality, because some sort of physical or electronic scanning often occurs in the imaging process. The particular components of the system and related circuitry, of course, differ greatly between modalities due to their different physics and data processing requirements.

Medical diagnostic systems of the type described above are often called upon to produce reliable and understandable images within demanding schedules and over a considerable useful life. Unfortunately, a particular medical facility may have a limited amount of funds, real estate, operating capacity, medical resources and medical procedures provided by those medical resources. If a patient requires a particular medical procedure, and the medical facility does not have the necessary medical resources, then the patient may need a referral to another medical facility having the requisite staff and equipment. Moreover, a patient may have a medical complication requiring a medical specialist or a specific medical system. Alternatively, the patient may desire to directly locate a particular medical resource without a doctor referral.

Accordingly, there is a need for a technique for geographically locating a desired medical resource based on client data. More particularly, there is a need for a medical resource locator system that searches for the desired medical resource, and then locates a plurality of medical facilities having the desired medical resource based on a desired geographic region. There is also a need for a medical resource locator system allowing interactive exchange of information, such as the desired geographic region for the desired medical resource, between a remote client interface and the medical resource locator system via a network. Moreover, there is a need for a resource location report providing the geographic location of the medical resources in the desired geographic region.

### SUMMARY OF THE INVENTION

The present technique is associated with geographically locating a medical resource. The technique allows a client to interact with a remote medical resource locator system via a network interface, and to enter and transmit client data to the medical resource locator system for a location analysis. Accordingly, the client receives a resource location report based on a desired geographic region for the medical resource.

According to one aspect of the present technique, a method may be provided for locating a medical resource. The method comprises electronically directing client data transmitted from a remote interface to a medical locator system via a network, and searching a database for a desired medical resource. The client data comprises a desired geographic region for locating the desired medical resource. The method also comprises locating at least one of the desired medical resources based on the desired geographic region, and electronically transmitting locator information to a client via the network.

According to another aspect of the present technique, an information system may be provided for locating a medical resource. The system comprises a resource locator system configured for locating a desired medical resource; and a remote interface configured for exchanging information with the resource locator system via a network. The remote interface has a form for transmitting client data to the resource locator system, the client data comprising a desired geographic region for locating the desired medical resource. The resource locator system is configured to evaluate the client data and to locate at least one of the desired medical resources based on the desired geographic region.

### BRIEF DESCRIPTION OF THE DRAWINGS

The foregoing and other advantages of the invention will become apparent upon reading the following detailed description with reference to the drawings in which:

FIG. 1 is a diagram of the present technique, illustrating an exemplary system for communication and data exchange between a plurality of medical clients and a data processing center remote from the medical clients;

FIG. 2 is a diagram of the present technique, illustrating an exemplary embodiment of the data processing center and data exchange between the data processing center and a client;

FIG. 3 is an exemplary flow chart of the present technique, with reference to the network interface pages of FIGS. 4, 5 and 6;

FIG. 4 is an exemplary query form for entering and transmitting client information from the client to the data processing center;

FIG. 5 is an exemplary results page for textually displaying medical resource location analysis results received by the client from the data processing center; and

FIG. 6 is an exemplary results page for graphically displaying medical resource location analysis results received by the client from the data processing center.

### DETAILED DESCRIPTION OF THE INVENTION

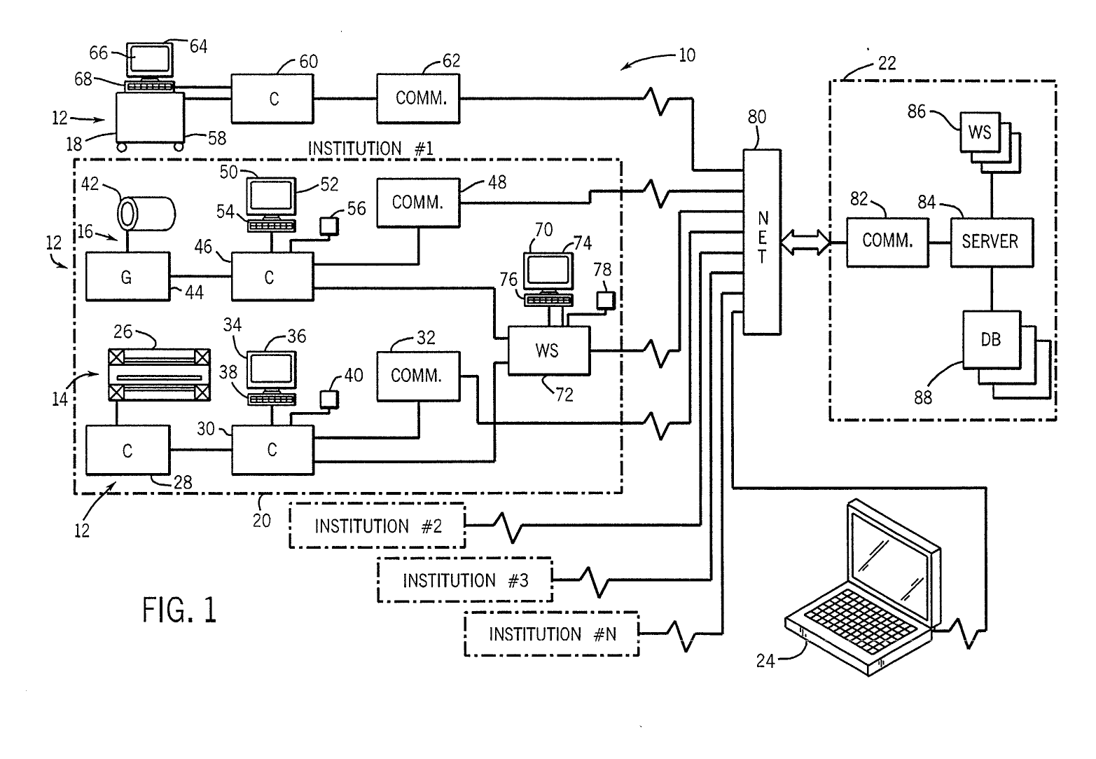

Turning now to the drawings, and referring first to FIG. 1, a communication system 10 is illustrated for providing remote data processing for a plurality of healthcare providers having a plurality of medical resources, such as medical diagnostic systems 12. In the embodiment illustrated in FIG. 1, the medical diagnostic systems 12 include a magnetic resonance imaging (MRI) system 14, a computed tomography (CT) system 16, and an ultrasound imaging system 18. The diagnostic systems 12 may be positioned in a single location or facility, such as institutions #1, #2, #3 and #N (e.g., medical facility 20), or may be remote from one another as illustrated for ultrasound imaging system 18. Each medical facility also may gain remote access to a data processing center 22 via the communication system 10. The data processing center 22 is also accessible via a remote client unit 24. Accordingly, multiple client workstations and medical institutions with various modalities have access to the data processing center 22.

In the exemplary embodiment of FIG. 1, several different medical clients (e.g., institutions #1, #2, #3 and #N) are provided with remote access to the data processing center 22. These and other medical clients may be provided access to, and benefit from, the data processing center 22, depending upon the capabilities of the data processing center 22, and other factors. However, the present technique is particularly well suited for remotely processing client data associated with a wide variety of medical diagnostic system modalities, including MRI systems, CT systems, ultrasound systems, positron emission tomography (PET) systems, nuclear medicine systems, and so forth. Moreover, the medical clients utilizing the data processing center 22 in accordance with the present techniques may be in different medical fields, may have different medical resources, and may have different types of patients. For example, medical resources may include a variety of medical equipment, systems, instruments and human resources for a particular medical procedure or medical practice. Furthermore, medical resources may include real estate, office space, healthcare service capacity, and financial resources of a particular institution. A variety of client data may be transmitted to the data processing center 22 via the communication system 10. For example, the client may transmit data from the medical diagnostic systems, data files from a computer, or data may be entered from a client computer coupled to the communication system 10 (e.g., remote client unit 24). The client data may comprise a variety of information associated with the client, the particular medical institution, and with the medical resources available to the particular medical institution. For example, the client data may comprise past and projected financial data/statistics, operational data/statistics, medical resources used or desired by the client, patient information, and other relevant client data from past operations or future projections.

The medical resources, as noted above, may comprise a variety of medical systems. Depending upon the modality of the systems, various subcomponents or subsystems will be included. In the case of MRI system 14, such systems will generally include a scanner 26 for generating pulsed magnetic fields and for collecting signals from emissions by gyromagnetic material within a subject of interest. The scanner is coupled to a control and signal detection circuit 28 which, in turn, is coupled to a system controller 30. The system controller 30 includes a uniform platform for interactively exchanging client data and processing requests with data processing center 22, as described more fully below. The system controller 30 is linked to a communications module 32, which may be included in a single or separate physical package from system controller 30. System controller 30 is also linked to an operator station 34, which will typically include a computer monitor 36, a keyboard 38, as well as other input devices 40, such as a mouse. In a typical system, additional components may be included in system 14, such as a printer or photographic system for producing reconstructed images based upon data collected from scanner 14. Although reference is made herein generally to “scanners” in diagnostic systems, that term should be understood to include medical diagnostic data acquisition equipment generally. Accordingly, it should not be limited to image data acquisition, to picture archiving communications and retrieval systems, nor to image management systems, facility or institution management systems, viewing systems and the like, in the field of medical diagnostics. More particularly, the medical resources may include imaging systems, clinical diagnostic systems, physiological monitoring systems, and so forth.

Similarly, CT system 16 will typically include a scanner 42, which detects portions of x-ray radiation directed through a subject of interest. Scanner 42 is coupled to a generator and controller, as well as to a signal acquisition unit, represented collectively at reference numeral 44, for controlling operation of an x-ray source and gantry within scanner 42, and for receiving signals produced by a detector array moveable within the scanner. The circuitry within the controller and signal acquisition components is coupled to a system controller 46 which, like controller 30 mentioned above, includes circuitry for commanding operation of the scanner and for processing and reconstructing image data based upon the acquired signals. System controller 46 is linked to a communications module 48, generally similar to communications module 32 of MRI system 14, for transmitting and receiving data for processing at the data processing center 22. Also, the system controller 46 is coupled to an operator station 50, which includes a computer monitor 52, a keyboard 54, as well as other input devices 56, such as a mouse. Moreover, like MRI system 14, CT system 16 will generally include a printer or similar device for outputting reconstructed images based upon data collected by scanner 42.

Other modality devices will include circuitry and hardware particularly configured for acquiring or producing signals in accordance with their particular design. In particular, in the case of ultrasound system 18, such systems will generally include a scanner and data processing unit 58 for transmitting ultrasound signals into a subject of interest, and for acquiring resultant signals which are processed for reconstructing a useful image. The system includes a system controller 60, which regulates operation of scanner 58 and which processes acquired signals to reconstruct the image. Moreover, system 18 includes a communications module 62 for transmitting client data and processing requests between system controller 60 and the data processing center 22. System 18 also includes an operators station 64, including a monitor 66, as well as input devices such as a keyboard 68.

Where more than one medical diagnostic system is provided in a single facility or location, as indicated in the case of MRI and CT systems 14 and 16 in FIG. 1, these may be coupled to a management station 70, such as in a radiology department of a hospital or clinic. The management station may be linked directly to controllers for the various diagnostic systems, such as controllers 30 and 46 in the illustrated embodiment. The management system may include a computer workstation or personal computer 72 coupled to the system controllers in an Intranet configuration, in a file sharing configuration, a client/server arrangement, or in any other suitable manner. Moreover, management station 70 will typically include a monitor 74 for viewing system operational parameters, analyzing system utilization, and exchanging client data and processing information between the facility 20 and the data processing center 22. Input devices, such as a standard computer keyboard 76 and mouse 78, may also be provided to facilitate the user interface. It should be noted that, alternatively, the management system, or other diagnostic system components, may be “stand-alone” or not coupled directly to a diagnostic system. Although the data processing center 22 may require a variety of client data to fully process a client request, the client data may not include medical system data derived directly from the medical system (e.g., CT and MRI systems). The client data may simply be transmitted from a client computer (e.g., remote client unit 24) after having been entered by the medical client. For example, the client data may be entered via an electronic form, or web interface.

The communication modules mentioned above, as well as workstation 72 and remote client unit 24, may be linked to data processing center 22 via a remote access network 80. For this purpose, any suitable network connection may be employed. Presently preferred network configurations include both proprietary or dedicated networks, as well as open networks, such as the Internet. Data may be exchanged between the institutions, medical resources, client computers and the remote data processing center 22 in any suitable format, such as in accordance with the Internet Protocol (IP), the Transmission Control Protocol (TCP), or other known protocols. Moreover, certain portions of the data may be transmitted or formatted via markup languages such as the HyperText Markup Language (HTML), Extensible Markup Language (XML), or other Internet and communication languages. Exemplary interface structures and communications components are described in detail below.

Within the data processing center 22, messages, client requests and client data are received by communication components as indicated generally at reference numeral 82. The communication components 82 direct the client data to a server, or a processing system 84, for the receipt, handling and processing of client data. In general, processing system 84 may include one or a plurality of computers, as well as dedicated hardware or software servers for processing the various requests and for receiving and transmitting the information as described more fully below. The data processing center 22 also may include a bank of workstations 86, which may be staffed by operators who address the processing requests and provide off and on-line assistance in response to the processing requests. Also, the processing system 84 may be linked to a set of databases or other processing systems 88 at or remote from the data processing center 22. Such databases and processing systems may include extensive database information on medical resources (e.g., medical systems), a particular medical facility, and so forth. As described below, such databases may be employed both for analyzing the client data and for processing the request transmitted by the client.

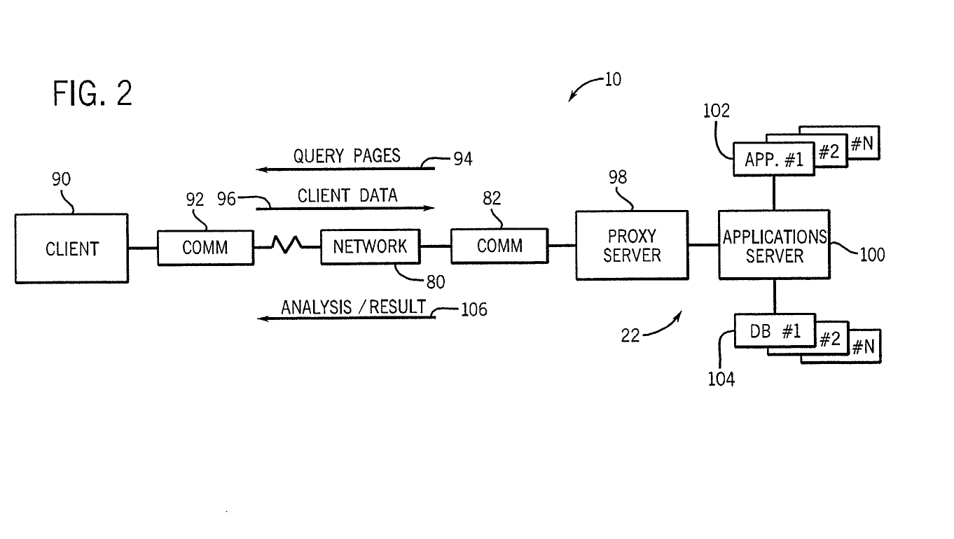

FIG. 2 is a diagram of the communication system 10, illustrating an exemplary embodiment of the data processing center 22 accessible by a client 90. The client 90 may be a medical facility, institution or individual interested in medical resources. The data processing center 22 may be associated with a medical supplier, a medical institution, or some other entity located remote from the client 90. For example, the data processing center 22 may be associated with a consulting firm, or some other performance/productivity management firm. The client 90 can communicate with the data processing center 22 via a communication device 92, which connects to the network 80 and the communication components 82 for the data processing center 22. The communication device 92 may be a modem or some other network device, allowing the client 90 to connect to the network 80 with a client computer system (e.g., remote client unit 24). The client 90 may access the network 80 via the Internet or other suitable network connections, thus the network 80 can be broadly interpreted to comprise all necessary networking between the client 90 and the data processing center 22.

In this exemplary embodiment, the client 90 electronically receives request pages 94 (e.g., data entry forms) from the data processing center 22, or an applications server for the network (e.g., Internet). For example, the client 90 may go to a web site having the request pages. The client 90 enters data, makes appropriate selections, and transmits a processing request to the data processing center 22. Accordingly, client data 96 is routed through the network 80 and to the data processing center 22, which may include a plurality of computer systems, servers, workstations, databases, and other hardware and software applications necessary for processing the client data. The client data 96 is received by a server (e.g., proxy server 98), which handles the request and directs the client data to the appropriate processing components, such as an applications server 100.

In this exemplary embodiment, the applications server 100 has appropriate applications 102 (e.g., application #1, #2 and #N) and databases 104 (e.g., database #1, #2, and #N) for analyzing the client data. Accordingly, a medical resource locator program (e.g., a geographic locator system) may be disposed on the applications server 100 with one or more medical resource databases, wherein the locator program is configured to search the databases for a desired medical resource in a desired geographic location (e.g., a geographic area, region, zip code, address or phone number). The applications server 100 may comprise a plurality of computer systems networked together, and may have one or more remote computer systems for a particular application. For example, a special application or database may be disposed at a remote location and/or may be provided by a separate entity (e.g., under a licensing agreement). In the present technique, the medical resource locator program may transmit locator information to a mapping program, which may be remote from the data processing center 22 (e.g., an Internet based mapping service). Moreover, a portion of the applications 102 may be disposed on a web server. For example, the medical resource locator program may embody an Internet based locator program tailored to geographically locate desired medical resources.

The applications server 100 and corresponding applications 102 and databases 104 collectively generate an analysis tailored to the client data 96, and provide a customized analysis report for the client 90 based on the client data 96. For example, the customized analysis report may provide locator information (e.g., contact information or geographic location information) as an ordered list (e.g., alphabetical or ranked in order of proximity to the desired location), or as a geographic map with a legend to the medical entities having the desired medical resources. The analysis and results 106 are then transmitted to the client 90 via the communication system 10. The results 106 may be formatted by the applications server 100, or transmitted as unformatted data for subsequent formatting by a client server or web server. For example, the data processing center 22 may generate user viewable pages based on the analysis. The client may then view the pages via a network interface, which may comprise a client computer system having an Internet browser or other appropriate software.

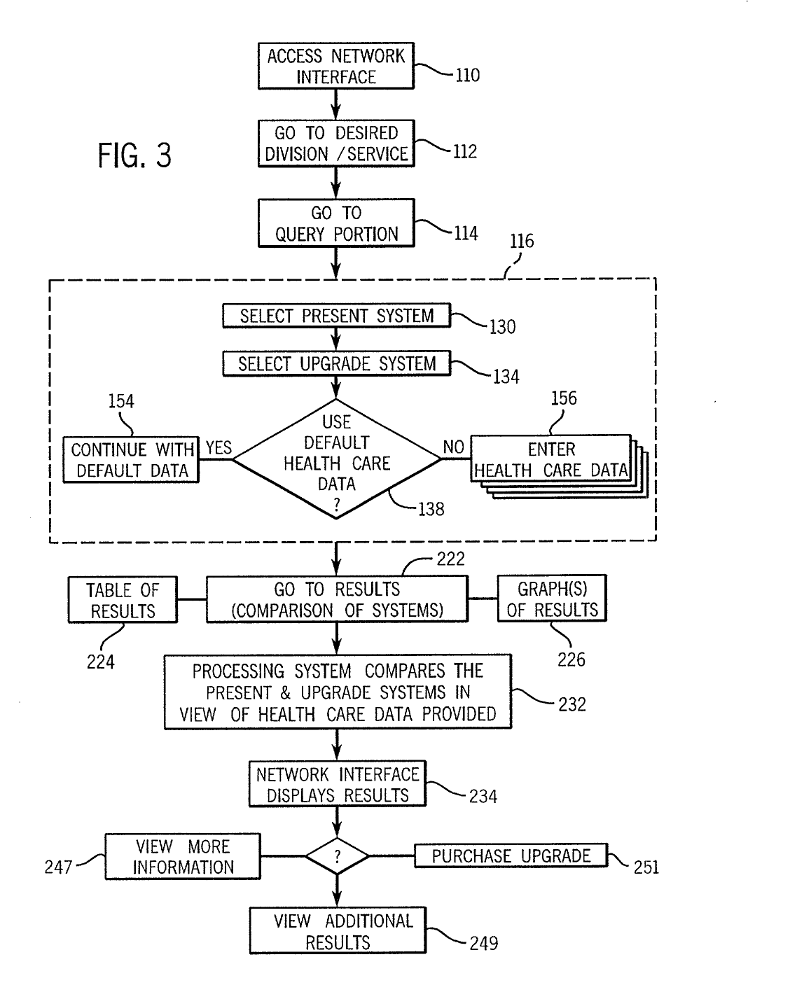

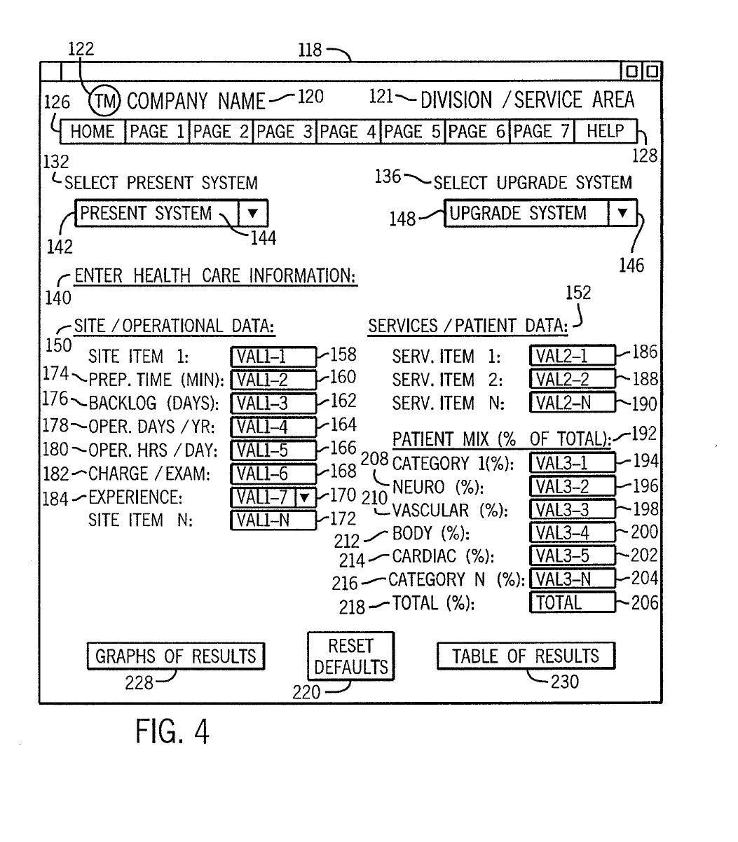

FIG. 3 is a flow chart of the present technique, illustrating communication and data exchange between the client 90 and the data processing center 22 remote from the client 90. To communicate with the data processing center 22, the client 90 accesses the network interface 110, which may include a variety of hardware and software such as a server, a client computer system and communication software. In this exemplary embodiment, the network interface comprises electronic forms, such as those illustrated in FIGS. 4, 5, and 6, allowing the client 90 to enter and transmit client data to the data processing center 22. For example, the network interface may be configured to access and display an Internet site (e.g., a website), requiring the client 90 to gain access to the website to view and browse the electronic forms. Accordingly, the network interface may comprise an Internet browser (e.g., Netscape or MS Internet Explorer) or other suitable software for displaying the electronic forms, provided that it allows the client 90 to transmit client data to the data processing center 22. Once the client 90 has access to the network interface, which may require a password and other login information, the client 90 may go to or browse to the desired division or service 112 displayable via the network interface. For example, if the network interface comprises an Internet website, the client 90 may browse the website and go to a page displaying the desired division or service 112. The division or service may be a financial service, a productivity service, or it may be a service associated with a particular medical resource. The client 90 then browses to or goes to a query portion 114, such as query section 116, of the electronic forms corresponding to that division or service, where a variety of questions are provided regarding the client 90 and the medical facility and/or resources associated with the client 90. FIG. 4 illustrates an exemplary query form 118, as discussed below.

In the present technique, the questions on the query form 118 are tailored to obtain a variety of client data, which may be relevant to a geographic location analysis of medical resources and/or healthcare services associated with a particular medical resource (e.g., medical product or system). Accordingly, the electronic forms may inquire into various matters that are relevant to locating the particular medical resources (e.g., desired location, experience of doctors and equipment operators, cost of procedure, wait time, etc.). Furthermore, the query form 118 may be tailored to the client 90, or it may allow the client 90 to enter client specific categories and data, rather than the queries illustrated in FIG. 4. In one aspect, the present technique comprises a locator system, which may be utilized by the client 90 to obtain a customized medical resource locator analysis based on the client data. An exemplary embodiment of this locator system utilizes the Internet, and provides an Internet based locator program for medical clients to locate a particular medical resource, which may include a desired geographic location among other criteria.

As illustrated in FIG. 4, the query form 118 comprises a plurality of data entry fields for the client 90 to enter client data associated with healthcare and medical resources. As illustrated, the query form 118 may indicate a company name 120, a trademark for the company 122, a service or division 124, and links to multiple pages such as home 126, page 1, page 2, page 3, page 4, page 5, page 6, page 7, and help page 128. In the query portion 116 of the query form 118, the client 90 may select the customer type 130 from a list of customer types 132, such as a healthcare provider 134, a consumer/patient 136, a type 3, a type 4, or a type N. The client 90 may also enter a location 138 in an enter location section 140, wherein the query form 118 may have a street section 141 with a text box 142 for entering a street, such as street 1. A city section 143 also may be provided with a drop-down menu 144 for selecting a city, such as city 1. Similarly, the query form 118 may have a state section 145 with a drop-down menu 146 for selecting a state, such as state s1. The query form also comprises a zip code section 147 having a text box 148 for entering a zip code, such as zip code 1. As illustrated in FIG. 4, the client 90 may have the option of entering only a zip code rather than entering street, city, and state information, as discussed above. Moreover, the location data entered in the location section 140 may be associated with the geographic location of the client, a patient of the client, another healthcare provider, or any other desired location for seeking a particular medical resource.

The query form 118 has a medical product/service type section 150 for selecting a product 152, selecting a service 154, and/or selecting a system 156. However, the query form 118 provides default choices for the product 152, the service 154, and the system 156, allowing the client 90 to browse default healthcare resources based on the default selections 158. If the client 90 accepts the default healthcare resources, then the client 90 may continue to locate default healthcare resources 160. Otherwise, the client 90 may enter or select the type of desired healthcare resources 162. To select the desired product 152, a drop-down menu 164 having a listing of medical products is provided, allowing the client 90 to select a product 1. To select the desired service 154, a drop-down menu 166 is provided for selecting a service, such as service 1. For selecting the desired system 156, a drop-down menu 168 is provided for selecting a system, such as system 1. Alternatively, the query form 118 allows a search by keywords 170 and provides a field 172 (e.g., a text box) for entering keywords such as keyword 1 and keyword 2. The client 90 may then depress a button, such as button 174 to find the products and services according to the keywords provided. The search by keywords 170 may bring up a separate window or page for displaying the results from the search based on keyword 1 and keyword 2. Moreover, the desired medical resources from section 150 may be associated with, or selected from, a plurality of modalities such as medical imaging systems. Once the query form 118 is completely filled out, the client 90 may search for healthcare resources 176 based on the location 140 entered in the query portion 116 by depressing a begin search button 178.

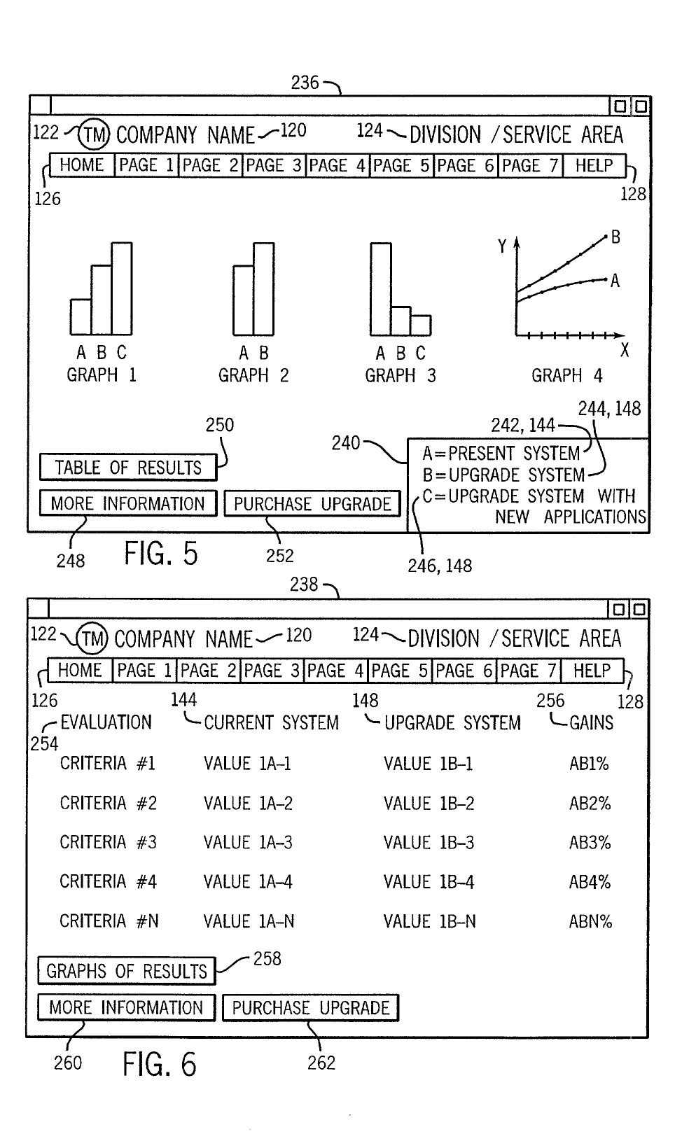

The client data or search criteria entered into the query portion of query form 118 is then transmitted to a processing system 180. The processing system (e.g., the data processing center 22) then analyzes the search criteria or client data and transmits site locations back to the network interface 182. In an exemplary embodiment, the processing system has a locator application, and a medical resource database having listings of a plurality of medical resources and location information associated with those medical resources. For example, the processing system may utilize a locator program to search a database for a specific healthcare resource, which may be a product, a service, or a system, and then search for instances of those healthcare resources based on the location entered 140 on the query form 118 (e.g., geographically within or near to the desired location or region). Once the analysis is complete, the processing system sends formatted or unformatted analysis data back to the network interface for display of the results 184. For example, the network interface may provide a list of healthcare institutions 186 based on an entered location 140, as illustrated in FIG. 5.

FIG. 5 is an electronics results page 188, providing a list of healthcare resources by site location 190 and a corresponding description of the healthcare resources 192. For example, an institution #1 is provided with an address 1 and a phone number 1, with a corresponding description of healthcare resources 1. Similarly, institutions 2 and N are listed with corresponding addresses 2 and N, phone numbers 2 and N, and corresponding descriptions of the healthcare resources 2 and N, respectively. The results page 188 also has option buttons 194, 196, and 198 for performing a new search, for viewing a map, and for requesting information, respectively. Instead of reviewing a results list, the network interface may display the results 184 as a map of healthcare institutions 200 in the area of the desired location 142, as illustrated in FIG. 6.

FIG. 6 is a map results page 202, which has a map of healthcare sites 204 and a corresponding list of the sites 206 based on the location 142 and the product/service type 150 entered on the query form 118. The sites are listed similarly to those on the results page 188, providing institutions, addresses, and phone numbers #1 through N, with corresponding labels or legend numbers for use on the map 204. For example, institution 1 is listed as 1, institution 2 is listed as 2, and institution N is listed as N, which corresponds to the numbers shown on the map of healthcare sites 204. If the client 90 is satisfied with the results, the client may simply print out 207 the results page 202 or 188. Alternatively, the client 90 may desire to perform a new search 208 or request additional information 210 by depressing a New Search button 212 or a Request Information button 214.

According to the embodiments illustrated in FIGS. 1-6, the present technique provides an exemplary method for geographically locating a desired medical resource. In one perspective, the present technique comprises electronically directing and receiving client data transmitted from a remote interface to a medical locator system via a network. The medical locator system may be wholly or partially disposed in the data processing center 22, a remote system, a web server, and various other hardware and software. The client data is then utilized by the medical locator system, to search a database and locate at least one instance a desired medical resource based on a desired geographic region. For example, the medical locator system may find multiple listings of the desired medical resource, each having a unique geographic location, and then select a number of those listings based on the desired geographic region. Once the medical locator system has analyzed the client data, a locator analysis may be electronically transmitted (e.g., via the communication system 10 and/or the Internet) to the client 90 via the network. The locator information may comprise medical institution names, addresses, phone numbers and a variety of information to ensure that the client is able to locate the desired medical resource in the desired region.

The present technique also may include providing the remote interface (e.g., the network interface). Accordingly, a variety of hardware and software may be provided and/or configured for the medical locator system, such as a client computer system, an applications server, a web server, databases, communications software, a web browser, a website, electronic forms, Internet forms, Internet pages, and/or a private network interface accessible via a dialup account or other networking. For example, the present technique may comprise setting up, and/or receiving client data from, a plurality of Internet forms having data entry fields (e.g., text boxes, drop-down menus, check boxes, buttons, etc.). For example, the data entry fields and/or client data may comprise the desired geographic region (e.g., address, zip code, etc.) and a selection of the desired medical resource from a plurality of medical resources (e.g., modalities or medical imaging systems). The present technique also may allow for the selection and receipt of multiple selections of desired medical resources, and for jointly locating the multiple selections based on the desired geographic region (e.g., locating CT and MRI systems based on one zip code, or locating both systems at one medical institution).

The present technique also may comprise a variety of resource location reports, and formats for presenting the reports. For example, the medical locator system may transmit locator information to the remote interface for display to the client 90 (e.g., a user viewable document). Alternatively, the medical locator system may link to a map system (e.g., an Internet mapping site) for mapping out the geographic location corresponding to the desired resources located by the medical locator system.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for locating a medical resource, the method comprising:
electronically directing client data transmitted from a remote interface to a medical locator system via a network, wherein the medical locator system is configured for multiple modalities, the client data comprising a desired geographic region for locating a desired medical resource for at least one of the multiple modalities;
searching a database for the desired medical resource;
locating at least one of the desired medical resources based on the desired geographic region; and
electronically transmitting locator information to a client via the network, the locator information allowing the client to locate the desired medical resource.

2. The method of claim 1, wherein electronically directing via the network comprises electronically directing via the Internet.

3. The method of claim 1, comprising providing the remote interface with a form for selecting the desired geographic region.

4. The method of claim 1, comprising receiving a selection of the desired medical resource from a plurality of medical resources.

5. The method of claim 4, wherein receiving the selection from the plurality of medical resources comprises receiving the selection from multiple modalities.

6. The method of claim 4, wherein receiving the selection from the plurality of medical resources comprises receiving the selection from a plurality of medical imaging systems.

7. The method of claim 5, wherein receiving the selection from multiple modalities comprises receiving the selection from multiple modalities comprising computed tomography.

8. The method of claim 5, wherein receiving the selection from multiple modalities comprises receiving the selection from multiple modalities comprising magnetic resonance imaging.

9. The method of claim 1, comprising locating the desired medical resource via address data for the desired geographic region.

10. The method of claim 1, comprising locating the desired medical resource via a postal code for the desired geographic region.

11. The method of claim 9, comprising locating via the address data of the remote interface.

12. The method of claim 1, wherein locating comprises ranking in order of proximity to the desired geographic region.

13. The method of claim 1, wherein electronically transmitting locator information comprises providing a list of addresses for the desired medical resources in closest proximity to the desired geographic region.

14. The method of claim 1, wherein electronically transmitting locator information comprises providing a map illustrating a geographic location of the desired medical resource.

15. The method of claim 1, comprising linking the medical locator system to a map system for mapping out a geographic location of the desired medical resource based on the desired geographic region.

16. An information system for locating a medical resource, the information system comprising:
a resource locator system configured for locating a desired medical resource; and
a remote interface configured for exchanging information with the resource locator system via a network, the remote interface having a form for transmitting client data to the resource locator system, the client data comprising a desired geographic region for locating the desired medical resource, wherein the resource locator system is configured to evaluate the client data and to locate at least one of the desired medical resources based on the desired geographic region.

17. The system of claim 16, wherein the network comprises the Internet.

18. The system of claim 16, wherein the remote interface comprises a server to communicate between the remote interface and the resource locator system via the network.

19. The system of claim 16, wherein the form comprises a field for selecting the desired geographic region.

20. The system of claim 16, wherein the form comprises a field for selecting the desired medical resource from a plurality of medical resources.

21. The system of claim 16, wherein the client data comprises a selection of the desired medical resource from a plurality of modalities.

22. The system of claim 16, wherein the client data comprises a selection of the desired medical resource from a plurality of medical imaging systems.

23. The system of claim 16, wherein the client data comprises multiple selections of desired medical resources from a plurality of medical resources.

24. The system of claim 16, wherein the client data comprises address data for the desired geographic region.

25. The system of claim 16, wherein the client data comprises a zip code for the desired geographic region.

26. The system of claim 16, comprising a map system for mapping out a geographic location of the desired medical resource based on the desired geographic region.

27. The system of claim 26, wherein the map system is remote from the resource locator system.

28. The system of claim 16, wherein the resource locator system comprises a locator database having a plurality of addresses for the desired medical resource.

29. A locator system for geographically locating a healthcare facility, the system comprising:
a resource locator system configured for locating a desired medical resource;
an address database of medical resources; and
a remote interface configured for exchanging information with the resource locator system via a network, the remote interface comprising a query form for transmitting client data to the resource locator system, the query form having a field for entering a desired geographic region for locating the desired medical resource, and a location results page having locator information for the desired medical resource.

30. The locator system of claim 29, wherein the query form comprises a field for selecting the desired medical resource from a plurality of medical resources comprising multiple modalities.

31. The locator system of claim 29, wherein the client data comprises multiple selections of desired medical resources from a plurality of medical resources.

32. The locator system of claim 29, wherein the client data comprises address data for the desired geographic region.

33. The locator system of claim 29, wherein the client data comprises a zip code for the desired geographic region.

34. The locator system of claim 29, wherein the location results page comprises a plurality of geographic locations for the desired medical resource ranked in order of proximity to the desired geographic region.

35. The locator system of claim 29, wherein the location results page comprises a list of addresses for the desired medical resource in closest proximity to the desired geographic region.

36. The locator system of claim 29, wherein the location results page comprises a map illustrating a geographic location of the desired medical resource.

37. The locator system of claim 29, comprising a map system remote from the resource locator system for mapping out a geographic location of the desired medical resource based on the desired geographic region.

38. A method for locating at least one medical resource from a plurality of medical resources, the method comprising:
electronically directing client data transmitted from a remote interface to a medical locator system via a network, the client data comprising a desired geographic region for locating at least one medical resource from the plurality of medical resources;
searching a medical locator database for the at least one medical resource;
geographically locating the at least one medical resource based on the desired geographic region;
electronically transmitting locator information to a client via the network, the locator information allowing the client to locate the desired medical resource; and
allowing the client to view the locator information via a resource location report viewable with the remote interface.

39. The method of claim 38, wherein electronically directing client data comprises electronically directing client data comprising a selection from a plurality of medical resources comprising multiple modalities.

40. The method of claim 38, wherein electronically directing comprises providing a server to procure network communication between the remote interface and the medical locator system.

41. The method of claim 38, comprising geographically locating the at least one medical resource via address data for the desired geographic region.

42. The method of claim 38, comprising geographically locating the at least one medical resource via a zip code for the desired geographic region.

43. The method of claim 38, wherein allowing the client to view the locator information via the resource location report comprises providing a list of addresses for the at least one medical resource in closest proximity to the desired geographic region.

44. The method of claim 38, wherein allowing the client to view the locator information via the resource location report comprises providing a map illustrating a geographic location of the at least one medical resource.

45. The method of claim 38, comprising linking the medical locator system to a remote map system for mapping out a geographic location of the at least one medical resource based on the desired geographic region.
